(19) United States
(12) Patent Application Publication
(10) Pub. No.: US 2014/0006308 A1
(43) Pub. Date: Jan. 2, 2014

(54) PORTION-BY-PORTION FEEDBACK FOR ELECTRONIC BOOKS

(71) Applicants: George Thomas Baggott, Menlo Park, CA (US); Thomas Germano O'Neill, Mountain View, CA (US)

(72) Inventors: George Thomas Baggott, Menlo Park, CA (US); Thomas Germano O'Neill, Mountain View, CA (US)

(73) Assignee: GOOGLE INC., Mountain View, CA (US)

(21) Appl. No.: 13/536,283

(22) Filed: Jun. 28, 2012

(51) Int. Cl. G06Q 30/00

(52) U.S. Cl. 705/347

(57) ABSTRACT

Feedback corresponding to a plurality of portions of an electronic book is collected. The feedback is analyzed to determine rating information corresponding to the plurality of portions. The rating information and a current reading position associated with a client device are used to determine information to be presented at the client device. In some instances, the feedback includes one or more implicit indicators.

### TECHNICAL FIELD

The disclosure relates generally to the field of electronic media, and specifically to systems and methods for generating and aggregating feedback for media objects such as electronic books at a fine grained level.

### BACKGROUND

Traditionally, feedback on media objects such as books, movies, and games, has been provided by expert reviewers. With the growth of the Internet, “crowd sourced” feedback has become increasingly popular. Typical crowd sourcing of feedback entails users (rather than professional reviewers) entering ratings and reviews into a feedback collection system. For example, the GOOGLE PLAY STORE™ enables users to rate a book with a score from one to five and provide a written review. These ratings and reviews are aggregated and made available to other users to inform their decisions regarding whether to purchase a particular book.

Some books begin poorly and then improve, while others begin with a bang but then tail off. Other books are made up of intermingled good and poor sections. A user may currently give up on a generally good book because the opening chapter was poor, or sit through the majority of a bad book because the opening chapter was enjoyable.

### SUMMARY

A computer-implemented method for providing feedback for an electronic book comprises: receiving feedback corresponding to a plurality of portions of the electronic book; analyzing the feedback to determine rating information corresponding to the plurality of portions; and preparing information for presentation to a user based on the rating information and the user's current reading position in the electronic book.

In one aspect, the presentation includes an indication of a change in rating information at a later position in the electronic book.

In another aspect, the feedback corresponds to measurements of biometric indicators. In further aspects, the feedback corresponds to numerical ratings. In one such aspect, analyzing the feedback includes calculating averages of the numerical ratings. In another such aspect, analyzing the feedback includes calculating average numerical ratings, wherein the contribution of a specific rating to an average is weighted based on a measure of similarity between the user reading the electronic book and the user that provided the feedback.

In yet another aspect, relative ratings for subsequent portions are determined by comparison with a rating for the current portion.

A computer system for collecting feedback for an electronic book comprising a plurality of portions comprises: a display; a display module; and a feedback module. The display module is configured to display the electronic book on the display and the feedback module is configured to collect a plurality of feedback measures corresponding to the plurality of portions.

In one aspect, the computer system also comprises a user data module and a data store. The user data module is configured to determine a current reading position within the electronic book and the data store is configured to store the feedback measures and indicators of one or more corresponding portions based on the current reading position.

In another aspect, the user data module is further configured to obtain user data corresponding to a user of the computer system and the data store is further configured to store the user data and a correspondence between the user data and the feedback measures. In yet another aspect, the display module is further configured to provide user controls on the display. The user controls enable the user to provide feedback via user input.

In further aspects the feedback measures correspond to measurements of one or more implicit indicators and/or numerical scores corresponding to each portion of the electronic book.

A computer system for processing feedback corresponding to a plurality of portions of an electronic book comprises: a processor; an aggregation module; and an analysis module. The aggregation module is configured to receive feedback corresponding to each of the plurality of portions. The analysis module is configured to interact with the processor to generate rating information corresponding to each of the plurality of portions, based on the feedback.

In one aspect, the computer system further comprises a presentation module. The presentation module is configured to generate presentation information to be presented at a client device. The presentation information is based on both the rating information and a current reading position associated with the client device.

In other aspects, the feedback corresponds to measurements of one or more indicators and/or one or more numerical scores corresponding to each portion of the electronic book.

In another aspect, the analyzing comprises calculating averages of one or more numerical scores corresponding to each portion. In a related aspect, the contribution of a specific score to an average is weighted based on a measure of similarity between a first user account and a second user account, where the first user account is associated with the client device and the second user account is associated with the specific score.

In yet another aspect, the presentation information is generated by determining a current portion from the plurality of portions based on the current reading position. Rating information for the current portion is compared to rating information for one or more subsequent portions and relative rating information is determined for the one or more subsequent portions.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a high-level block diagram illustrating a networked computing environment, consistent with one embodiment.

FIG. 2 is a high-level block diagram illustrating an example of a computer for use in the computing environment shown in FIG. 1.

FIG. 3 is a high-level block diagram illustrating a client device suitable for use in the networked computing environment shown in FIG. 1, according to one embodiment.

FIG. 4 is a high-level block diagram illustrating the feedback subsystem of the cloud provider facility of FIG. 1, according to one embodiment.

FIG. 5 is a flowchart illustrating a method for generating aggregated fine-grained feedback, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### System Overview

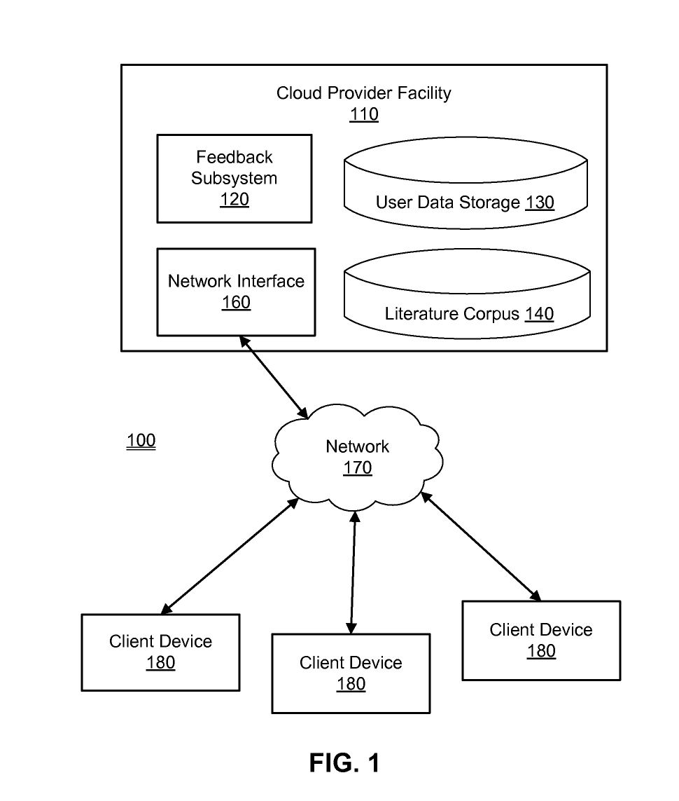

It would be advantageous to readers if a crowd sourced feedback system not only gave an overall rating for a book, but also ratings for individual sections and indicators regarding whether the book is going to improve, get worse, or stay at the same level, if the reader continues. FIG. 1 shows a networked computing environment 100 for addressing this by providing portion-by-portion feedback for electronic books, consistent with one embodiment. The networked computing environment 100 includes a cloud provider facility 110 and a plurality of client devices 180, of which three are shown for exemplary purposes only. The client devices 180 and cloud provider facility are connected by a network 170.

The cloud provider facility 110 makes available for purchase, licensing, rental or subscription books that can be viewed on the client devices 180. In addition, the cloud provider facility 110 collects and analyzes feedback to provide rating information to users regarding both full books and individual sections of those books (e.g., chapters, pages, paragraphs, and the like), and, in some embodiments, an indicator as to whether, based on input from other readers, the book will improve in quality, get worse, or stay at the same level if the user continues to read. In contrast to the manner in which some digital music stores enable users to rate whole albums as well as individual songs, individual sections of a book (unlike individual songs) are not fully independent conceptual entities. Whereas the songs on an album can meaningfully be listened to individually without knowledge of the rest of the album, it makes very little sense to read, for example, only chapter 3 of a novel.

The network 170 is typically the Internet, but can be any network, including but not limited to any combination of a LAN, a MAN, a WAN, a mobile, a wired or wireless network, a private network, or a virtual private network. The cloud provider facility 110 is connected to the network 170 through a network interface 160.

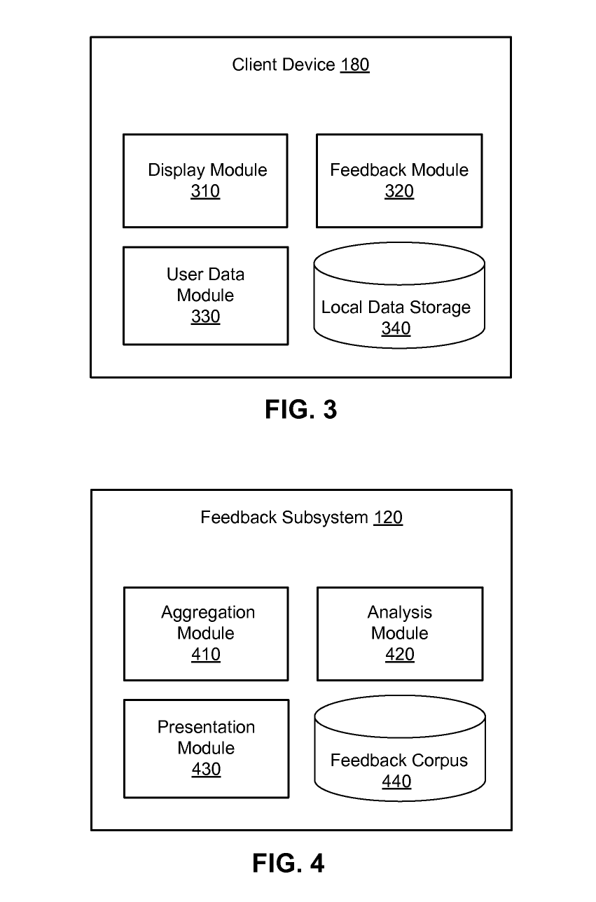

The client devices 180 can be any computing device capable of displaying an electronic book to a user, such as desktop PCs, laptops, smartphones, PDAs, electronic book readers, and the like. As discussed above, although only three client devices 180 are shown, in practice there are many (e.g., millions of) client devices 180 that can communicate with and the cloud provider facility 110 using the network 170. An exemplary client device is described in greater detail below, with reference to FIG. 3.

In the illustrated embodiment, the cloud provider facility 110 includes a feedback subsystem 120, a network interface 160, user data storage 130 and a literature corpus 140. The network interface 160 enables the various components of the cloud provider facility 110 to communicate with each other internally, as well as with the client devices 180 via the network 170. Other embodiments of the cloud provider facility 110 include different and/or additional components. In addition, the functions may be distributed among the components in a different manner than described herein.

The literature corpus 140 comprises one or more data storage devices that hold a collection of electronic books that are available for access from client devices 180. Modern electronic books are not limited to mere collections of digital text. Electronic books comprise many different combinations of text, images, music, sound effects, video, interactive features, and the like. In some embodiments, metadata is embedded in all or some of the electronic books. The term metadata is used herein to encompass all data corresponding to a book that is available in the computing environment 100. In other embodiments, portion-by-portion feedback is provided for other types of media object, including, but not limited to: movies; games; TV shows; and any other such entity.

The user data storage 130 comprises one or more data storage devices (which may be the same devices that make up the literature corpus 140) that hold information about user accounts. Typically, when a user wishes to access the services provided by the cloud provider facility 110 the user will log into the cloud provider facility by providing authentication data (for example a username and password) that are verified against user records stored in the user data storage 130.

In some embodiments, the user data storage 130 also contains data about reading histories associated with user accounts, such as a list of books read and a current position in one or more books that the user is yet to complete. The storage of current positions as part of user account data enables, amongst other things, users to pick up reading at the point the user last stopped, even if the user is using a different client device 180. In one such embodiment, the user data storage 130 may contain user profile information, such as age, interests, books the user likes, books the user dislikes, and books the user started reading but did not complete. In one embodiment, if a user provides advance consent to allow the collection of usage data, such data may be collected. Even in such an embodiment, however, the user is provided with a user interface control to let them opt out of such data collection.

The feedback subsystem 120 collects and analyses feedback regarding books and sections thereof from users, and processes the results for presentation to users at one or more of the client devices 180. In various embodiments, the feedback is collected using different combinations of one or more implicit and/or explicit signals. In some embodiments where feedback is collected from implicit signals, the user is informed of what information will be gathered and provided with an opportunity to consent or opt out. The feedback subsystem is described in greater detail below, with reference to FIGS. 3 and 4.

### Computing System Architecture

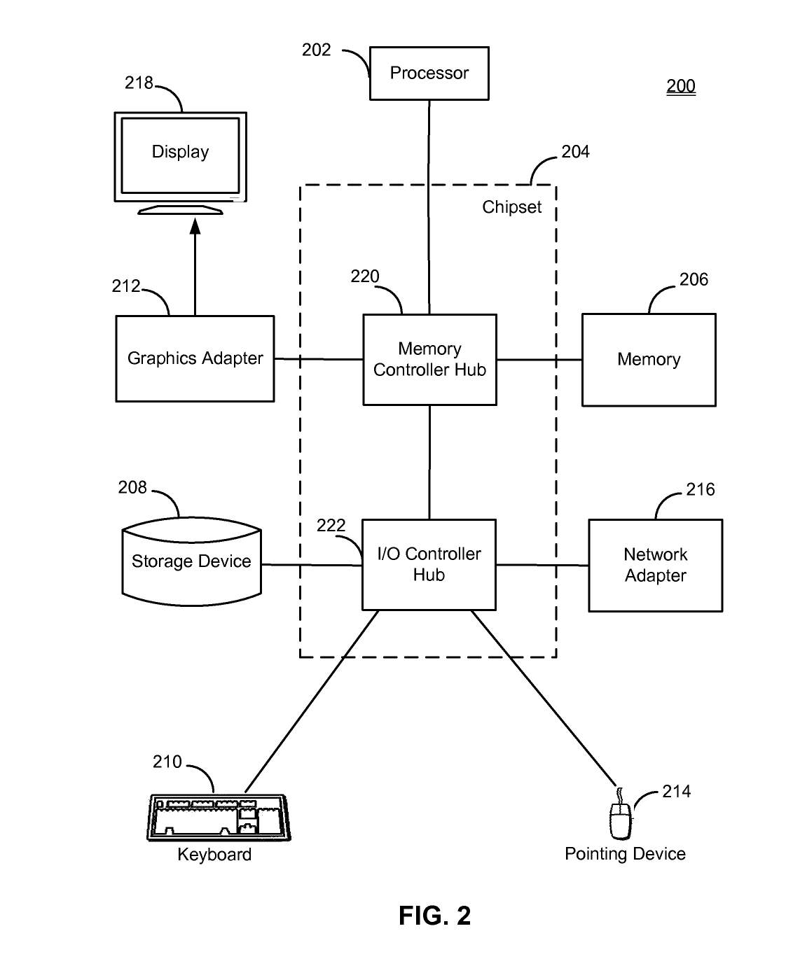

The entities shown in FIG. 1 are implemented using one or more computers. FIG. 2 is a high-level block diagram illustrating an example computer 200. The computer 200 includes at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display 218 is coupled to the graphics adapter 212. A storage device 208, keyboard 210, pointing device 214, and network adapter 216 are coupled to the I/O controller hub 222. Other embodiments of the computer 200 have different architectures.

The storage device 208 is a non-transitory computer-readable storage medium such as a hard drive, compact disk read-only memory (CD-ROM), DVD, or a solid-state memory device. The memory 306 holds instructions and data used by the processor 202. The pointing device 214 is a mouse, track ball, or other type of pointing device, and is used in combination with the keyboard 210 to input data into the computer system 200. The graphics adapter 212 displays images and other information on the display 218. The network adapter 216 couples the computer system 200 to one or more computer networks.

The computer 200 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 208, loaded into the memory 206, and executed by the processor 202.

The types of computers used by the entities of FIG. 1 can vary depending upon the embodiment and the processing power required by the entity. For example, the cloud provider facility 110 might comprise multiple blade servers working together to provide the functionality described herein, whereas client devices 180 might be tablet computing devices. The computers can lack some of the components described above, such as keyboards 210, graphics adapters 212, and displays 218.

### System Details

FIG. 3 is a high-level block diagram illustrating a client device 180 suitable for presenting an electronic book and fine-grained feedback to a user, according to one embodiment. The client device shown includes a display module 310, a feedback module 320, a user data module 330, and local data storage 340. Other embodiments of client devices 180 include different and/or additional modules. In addition, the functions may be distributed among the modules in a different manner than described herein.

The display module 310 receives at least part of an electronic book and presents it to the user on a screen. Alternatively, the display module 310 presents the electronic book in audio form using either text to speech or a pre-recorded narration. In one embodiment, the user has pre-downloaded the electronic book from the cloud provider facility (e.g., by purchasing the electronic book from GOOGLE PLAY STORE™) and the display module 310 accesses the electronic book from local data storage 340. In another embodiment, the display module 310 directly accesses a remote copy of the book stored in the literature corpus 140, via the network 170.

The feedback module 320 collects feedback from the user regarding the electronic book currently being displayed by the display module 310. In one embodiment, the feedback is stored in local data storage 340. In another embodiment, the feedback is sent to the cloud provider facility 110 and stored in user data storage 130. In further embodiments, the feedback is initially stored in local data storage 340 before being processed and sent to cloud provider facility 100 by the feedback module 320. For example, in one embodiment the feedback module 320 compiles user ratings for sections of the book and normalizes the section ratings based on a user provided rating for the whole book. Once the user has completed the book, the feedback module 320 sends the normalized ratings to the cloud provider facility 110, assuming the user has provided advance consent for such data to be collected.

As discussed above, there are many different ways in which feedback can be collected. In one embodiment, the display module 310 displays a “+1” control associated with each section of the electronic book. When a user selects such a “+1” control, the feedback module 320 stores an indication that the user likes that section of the book. In another embodiment, the display module 310 provides user controls to enable the user to rate each section from 1 to 5.

In one embodiment, the display module 310 presents user controls concurrently with the electronic book to solicit feedback from the user, for example by showing “like” and “dislike” buttons in a bottom portion of the display of the book reader. In another embodiment, the display module 310 actively solicits feedback from the user by asking for a rating for the chapter of the electronic book that the user has just read before displaying the next chapter. In further embodiments, the feedback module 320 uses implicit indicators as feedback measures (e.g., measures of: reading rate; length of reading sessions; time between reading sessions; how often a portion of the book is shared on social networks; and the like). Other implicit indicators can be monitored using one or more input devices of the client devices 180. One of skill in the art will recognize that a wide array of input devices and implicit indicators can be used without deviating from the spirit and scope of this disclosure.

The user data module 330 collects and processes data relating to the user obtained from at least one of: user input, local data storage 340, and the cloud provider facility 110. In one embodiment, the user data module 330 stores the user's current position in the electronic book. This data is useful both to enable the display module 310 to automatically open the electronic book the user's current position at the start of a reading session, and to enable the display module 310 to display position specific feedback information to the user. In another embodiment, the user data module 330 also collects information about the user (e.g., demographic information) for use in processing feedback collected by the feedback module 320. The use of user data is described below with reference to FIG. 4.

FIG. 4 is a high-level block diagram illustrating the feedback subsystem 120 of the cloud provider facility 110, according to one embodiment. In the embodiment shown, the feedback subsystem 120 comprises an aggregation module 410, and analysis module 420, a presentation module 430, and a feedback corpus 440. Other embodiments of the analysis module 110 include different and/or additional modules. In addition, the functions may be distributed among the modules in a different manner than described herein.

The feedback corpus 440 comprises one or more data storage devices that hold feedback that has been provided by users via the client devices 180. The feedback corpus 440 may also comprise supplementary feedback provided by system administrators and/or expert reviewers. In one embodiment, the actual feedback entered into the client devices 180 is stored, e.g., if one million users provide feedback scores on a scale of one to five, then all of the one million ratings are stored as part of the feedback corpus 440. In another embodiment, an aggregated representation of data is stored, e.g., if one million ratings are provided, an average value and the total number of values used to calculate the average value are stored in the feedback corpus 440. Amongst other advantages, this approach reduces the amount of data storage required and thereby increases access speeds.

The aggregation module 410 collects feedback that has been provided at the client devices 180 and stores it in the feedback corpus 440. As described above, the precise manner in which the aggregation module 410 stores feedback in the feedback corpus 440 is dependent on the specific embodiment. In some embodiments, feedback is provided at set intervals (e.g., the end of a chapter) while in others it is nearly continuous.

In one embodiment, a client device 180 immediately pushes new feedback information to the feedback subsystem 120 after it is collected by the feedback module 320 of the client device. In a related embodiment, the client device 180 only pushes new feedback data if more than a threshold amount of time (e.g., 5 minutes) has passed since the client device last pushed feedback data. The use of a threshold time prevents the network 170 from being flooded with data packets by a client device 180 that is collecting a large amount of feedback data. In other embodiments, the aggregation module 410 polls the client devices 180 at specific times (e.g., when a user logs in, or if more than a threshold period has elapsed since a previous update) for any new feedback that has not yet been added to the feedback corpus 440.

The analysis module 420 analyzes the data in the feedback corpus 440 to generate aggregated feedback scores and information relating to an electronic book and the individual sections thereof. In some embodiments, the analysis module 420 determines a score for each section of the book based on the total number of users that selected “+1” for each section. In one such embodiment, the score for each section is equal to the number of “+1s” the section has received. In another such embodiment, the score is determined by normalizing the total count to the number of users who provided a “+1” rating to at least one section of the book.

In other embodiments, the analysis module 420 determines a score for each section of the book based on a plurality of ratings (e.g., scores from one to five) for each section. In one such embodiment, the analysis module 420 calculates the scores corresponding to each section by finding the mean of all ratings provided as feedback for that section. One of skill in the art will recognize that other algorithms for converting a plurality of ratings for a section into a corresponding score are possible without deviating from the spirit or scope of this disclosure.

In further embodiments, the analysis module 420 determines a score for each section of the book based on implicit feedback gathered by the client devices 180 relating to one or more implicit indicators. In one such embodiment, the analysis module 420 gathers both explicit ratings and other data and uses the explicit ratings to calibrate the interpretation of the other data for a specific user.

The analysis module 420 initially compares explicit ratings provided by a user with the other data collected from the user while the user is reading. If the analysis module determines a correlation exists between the explicit feedback and the other data this correlation is stored as part of the user's profile in the user data storage 130. Once a correlation is determined, the analysis module 420 continues to collect such other data and analyses it to generate implicit feedback, which is added to the feedback corpus 440. In one embodiment, the analysis module 420 compares the explicit and implicit feedback and uses a machine learning algorithm to validate and improve the correlation used to generate implicit feedback.

In some embodiments, the analysis module 420 calculates personalized scores based on profile information stored in the user data storage 130. The analysis module 420 compares profile information associated with feedback with profile information associated with a currently logged-in user to determine a degree of similarity. In one such embodiment, the analysis module 420 only considers feedback generated by user profiles with more than a threshold level of similarity compared to the logged-in user profile when calculating ratings. In another such embodiment, the contribution of a piece of feedback to a rating calculation is weighted by a factor based on the degree of similarity.

The presentation module 430 prepares the data generated by the analysis module 420 for presentation at a client device 180. In one embodiment, the presentation module 430 generates a graph for an electronic book with portion identifier on a first axis and portion rating on a second axis. A client device 180 displays the graph as part of a summary of the electronic book, thus enabling a user to quickly see not just a general rating for the book as a whole, but also where the highly and not so highly rated sections are situated.

In other embodiments, the presentation module 430 considers a current reading position when preparing the data generated by the analysis module 420 for presentation at a client device 180. By considering the current reading position and the portion-by-portion scores, the presentation module 430 determines relative rating information for proceeding sections compared to the current section. This information is prepared for presentation to the user at a client device 180.

In one such embodiment, the user is presented with a visual indication of whether the next part of an electronic book will be better, worse, or of the same quality as the current part. For instance, a graphical “trending arrow” display that goes upward, horizontally or downward, is used in some embodiments to indicate better, neutral, or worse trending of user feedback for upcoming portions of the text. In other such embodiments, the visual indication relates to a difference in rating between the current section and a plurality of following sections.

Further such embodiments present the relative rating information in different ways. For example, if the current section is part of a low-rated section, but a significant increase in rating is identified as occurring three chapters later, the user can be issued with a message encouraging the user to continue, such as “keep going, this is about to get awesome!” Conversely, if the feedback provided by a user (either implicitly or explicitly) indicates that the user is not enjoying a book, and the aggregated feedback for the remainder of the book does not indicate an improvement, the user can be presented with a message suggesting that the user may wish to discontinue reading.

In some embodiments, relative rating information for a specific book is presented to the user while the user is reading that book. For example, a trending arrow may be presented in a corner of the display of the book reader, or a message may be presented as a pop-up. In other embodiments, the relative rating information is presented to the user on a screen showing the user some or all of the books owned by the user. In one such embodiment, when the user is viewing a list of all owned books, each book is shown with a trend arrow indicating whether the aggregated feedback indicates the book improves, gets worse, or stays the same in the sections immediately following the user's current reading position. In another such embodiment, the book reader determines that the user hasn't opened a particular book for a set amount of time (e.g., a week). If the aggregated feedback indicates that the book is about to improve, a message such as “you're about to get to the best bit!” is included when displaying a list of the user's electronic book collection.

### Exemplary Method

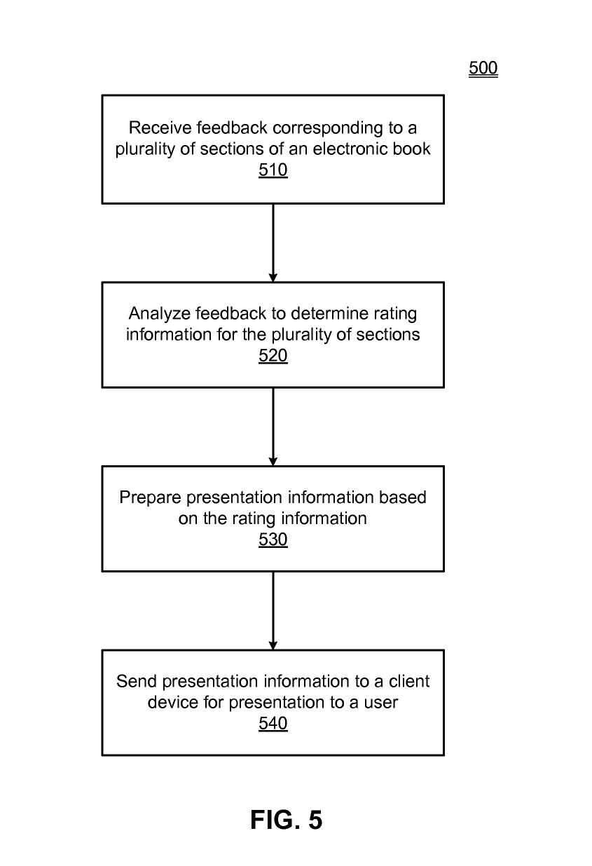

Turning now to FIG. 5, a flowchart is shown illustrating a method 500 for generating aggregated fine-grained feedback, according to one embodiment. FIG. 5 attributes the steps of the method to the cloud provider facility 110. However, some or all of the steps may be performed by other entities. In addition, some embodiments may perform the steps in parallel, perform the steps in different orders, or perform different steps.

At step 510, the aggregation module 410 receives feedback that corresponds to a plurality of sections of an electronic book. In one embodiment, the feedback is crowd sourced and gathered incrementally, with feedback being added to the feedback corpus 440 indefinitely as the cloud service provider 110 operates. As described above, the feedback can be collected in many different forms.

At step 520, the analysis module 420 analyzes the collected feedback to determine rating information corresponding to the plurality of sections. As described above, various embodiments use different methods for combining the feedback corresponding to a section to generate rating information for that section. The rating information can be in the form of one or more numerical ratings, classifications, and other measures that can be used to compare the relative quality of one section with another.

At step 530, the presentation module 430 prepares presentation information based on the rating information and, in some embodiments, a current reading position associated with a user. The presentation information represents the rating information in a manner which is useful to the user. For example, as described above, the presentation information can take the form of a relative rating informing the user that an upcoming section is better than the current section.

At step 540, the feedback subsystem 120 sends the presentation information to a client device 180 associated with the user. The client device 180 displays the presentation information to the user in a suitable manner, such as a display segment co-displayed with the electronic book or as part of a summary of an electronic book. In some embodiments, further feedback in acquired by asking the user to rate the accuracy of the presentation information. This is particularly useful in embodiments that utilize machine learning techniques to continually improve feedback analysis, as discussed above.

### Additional Considerations

In this description, the term “module” refers to computational logic for providing the specified functionality. A module can be implemented in hardware, firmware, and/or software. Where the modules described herein are implemented as software, the module can be implemented as a standalone program, but can also be implemented through other means, for example as part of a larger program, as a plurality of separate programs, or as one or more statically or dynamically linked libraries. It will be understood that the named modules described herein represent one embodiment of the present invention, and other embodiments may include other modules. In addition, other embodiments may lack modules described herein and/or distribute the described functionality among the modules in a different manner. Additionally, the functionalities attributed to more than one module can be incorporated into a single module.

In an embodiment where the modules as implemented by software, they are stored on a computer readable persistent storage device (e.g., hard disk), loaded into the memory, and executed by one or more processors included as part of a client device 180 and/or cloud provider facility 110. Alternatively, hardware or software modules may be stored elsewhere within the networked computing environment 100. The networked computing environment 100 includes hardware elements necessary for the operations described here, including one or more processors, high speed memory, hard disk storage and backup, network interfaces and protocols, input devices for data entry, and output devices for display, printing, or other presentations of data.

Numerous variations from the system architecture of the illustrated computing environment 100 are possible. The components of the environment 100 and their respective functionalities can be combined or redistributed. For example, the literature corpus 140 can be distributed among any number of physical devices.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for protecting user data from unauthorized access. Thus, while particular embodiments and applications have been illustrated and described, it is to be understood that the present disclosure is not limited to the precise construction and components disclosed herein and that various modifications, changes and variations which will be apparent to those skilled in the art may be made in the arrangement, operation and details of the method, system, and storage medium disclosed herein without departing from the spirit and scope as defined in the appended claims.

1. A computer-implemented method for providing feedback for an electronic book comprising a plurality of portions, the method comprising:
receiving, at a processor, a plurality of user feedback measures, each of the user feedback measures corresponding to one of the plurality of portions;
analyzing, by a processor, the user feedback measures to determine rating information corresponding to the plurality of portions;
receiving, at a processor, a current reading position associated with the client device;
identifying a current portion of the plurality of portions based on the current reading position;
identifying rating information corresponding to the current portion;
identifying rating information corresponding to at least one additional portion of the plurality of portions; and
preparing, by a processor, presentation information for presentation at a client device, the presentation information indicating a difference between the rating information corresponding to the current portion and the rating information corresponding to the at least one additional portion.

2. The method of claim 1, wherein the presentation information includes an indicator of a change in rating information at a later position in the electronic book.

3. The method of claim 1, wherein the user feedback measures correspond to measurements of one or more implicit indicators.

4. The method of claim 3, wherein the one or more implicit indicators include a measure of at least one of: reading rate; reading session time; time between reading sessions; and how many times a particular portion has been shared on a social network.

5. The method of claim 1, wherein the user feedback measures comprise one or more numerical scores corresponding to each portion.

6. The method of claim 5, wherein analyzing comprises calculating averages of the one or more numerical scores that correspond to each portion.

7. The method of claim 6, wherein calculating averages of the one or more numerical scores that correspond to each portion comprises determining a weighting for a first score of the one or more numerical scores, the weighting based on a measure of similarity between a first user account and a second user account, the first user account being associated with the client device and the second user account being associated with the first score.

8. The method of claim 2, wherein the indicator is one of: an indicator that a next portion is better than the current portion; an indicator that the next portion is worse than the current portion; and an indicator that the next portion is neither better nor worse than the current portion.

9. The method of claim 1, wherein the electronic book further comprises at least one of: audio; video; and interactive content.

10. A computer system for presenting feedback for an electronic book comprising a plurality of portions, the system comprising:
a display;
a display module configured to display the electronic book on the display;
a user data module operably connected to the display module and configured to determine a current portion of the plurality of portions based on a reading position within the electronic book; and
a feedback module operably connected to the display module and the user data module, the feedback module configured to cause presentation information to be presented to a user, the presentation information comprising an indication of a difference between rating information corresponding to the current portion and rating information corresponding to at least one additional portion of the plurality of portions.

11. The system of claim 10, wherein the indication is one of: an indicator that a next portion is better than the current portion; an indicator that the next portion is worse than the current portion; and an indicator that the next portion is neither better nor worse than the current portion.

12. The system of claim 10, wherein the user data module is further configured to obtain user data corresponding to a user of the computer system and the presentation information is based on the user data.

13. The system of claim 10, wherein the feedback module is further configured to provide user controls on the display, the user controls enabling a user to provide feedback for the current portion, the presentation information being based on the feedback.

14. The system of claim 10, wherein the feedback module is further configured to collect feedback for the current portion via measurements of one or more implicit indicators, the presentation information being based on the feedback.

15. The system of claim 14, wherein the one or more implicit indicators include a measure of at least one of: reading rate; reading session time; time between reading sessions; and how many times a particular portion has been shared on a social network.

16. The system of claim 13, wherein the feedback is one or more numerical scores.

17. The system of claim 10, wherein the electronic book further comprises at least one of: audio; video; and interactive content.

18. A computer system for processing feedback corresponding to a plurality of portions of an electronic book, the system comprising:
a processor;
an aggregation module configured to receive a plurality of feedback measures, each feedback measure corresponding to one of the plurality of portions;
an analysis module configured to interact with the processor to generate rating information corresponding to each of the plurality of portions, based on the feedback measures; and
a presentation module configured to: identify a current portion of the plurality of portions based on the current reading position; identify rating information corresponding to the current portion; identify rating information corresponding to at least one additional portion of the plurality of portions; and generate presentation information for presentation at a client device, the presentation information indicating a difference between the rating information corresponding to the current portion and the rating information corresponding to the at least one additional portion.

19. The system of claim 18, wherein the presentation information includes an indicator of a change in rating information at a later position in the electronic book.

20. The system of claim 18, wherein the feedback measures correspond to measurements of one or more implicit indicators.

21. The system of claim 20, wherein the one or more implicit indicators include a measure of at least one of: reading rate; reading session time; time between reading sessions; and how many times a particular portion has been shared on a social network.

22. The system of claim 18, wherein the feedback measures comprise one or more numerical scores corresponding to each portion.

23. The system of claim 22, wherein analyzing comprises calculating averages of the one or more numerical scores that correspond to each portion.

24. The system of claim 23, wherein calculating averages of the one or more numerical scores that correspond to each portion comprises determining a weighting for a first score of the one or more numerical scores, the weighting based on a measure of similarity between a first user account and a second user account, the first user account being associated with the client device and the second user account being associated with the first score.

25. The system of claim 19, wherein the indicator is one of: an indicator that a next portion is better than the current portion; an indicator that the next portion is worse than the current portion; and an indicator that the next portion is neither better nor worse than the current portion.

26. The system of claim 18, wherein the electronic book comprises at least one of: audio; video; and interactive content.

27. A computer system for presenting feedback for an electronic book comprising a plurality of portions, the system comprising:
means for presenting the electronic book to a user;
a user data module operably connected to the display module and configured to determine a current portion of the plurality of portions based on a reading position within the electronic book; and
means for presenting an indication of a difference between rating information corresponding to the current portion and rating information corresponding to at least one additional portion of the plurality of portions.
